(19) United States
(12) Patent Application Publication
(10) Pub. No.: US 2023/0108298 A1
(43) Pub. Date: Apr. 6, 2023

(54) METHODS, SYSTEMS, AND DEVICES FOR MEASURING UPLINK INGEST PERFORMANCE OF LIVE VIDEO CONTENT STREAMING

(71) Applicants: AT&T Intellectual Property I, L.P., Atlanta, GA (US); The Regents of the University of Michigan, Ann Arbor, MI (US)

(72) Inventors: Subhabrata Sen, Westfield, NJ (US); Zhuoqing Morley Mao, Ann Arbor, MI (US); Xiao Zhu, Ann Arbor, MI (US)

(73) Assignees: AT&T Intellectual Property I, L.P., Atlanta, GA (US); The Regents of the University of Michigan, Ann Arbor, MI (US)

(21) Appl. No.: 17/487,190

(22) Filed: Sep. 28, 2021

(51) Int. Cl. H04L 29/06; H04L 12/26

(52) U.S. Cl. CPC H04L 65/607; H04L 43/0829; H04L 43/0888; H04L 65/80; H04L 65/601

(57) ABSTRACT

Aspects of the subject disclosure may include, for example, obtaining and decoding a video file to obtain raw frames, providing the raw frames to the virtual camera that generates video content from the raw frames, providing the video content to a broadcasting application on a first communication device that provides output frames, and providing network conditions that are applied to the output frames resulting in conditioned output frames. The conditioned output frames are provided to a video content server from the first communication device, the video content server provides ABR tracks to a second communication device, the ABR tracks are associated with the conditioned output frames in response to receiving requests for the ABR tracks. Also, embodiments include obtaining and analyzing the conditioned output frames, the ABR tracks, and the requests, and generating metrics associated with the broadcasting application based on the analysis. Other embodiments are disclosed.

### FIELD OF THE DISCLOSURE

The subject disclosure relates to methods, systems, and devices for measuring uplink ingest performance of live video content streaming.

### BACKGROUND

Over-the-top (OTT) live streaming video traffic has grown significantly, fueled by fundamental shifts in ways users consume video content (e.g., increased cord-cutting) and by improvements in camera technologies, computing power, and wireless resources. As per one industry study, live streaming of video content is expected to account for more than 15% of the video traffic on the Internet by 2022. An end-to-end (E2E) live streaming pipeline comprises of an uplink ingest path and a downlink distribution path. On the uplink ingest path, the video content is captured in real time by a camera on a communication device (e.g., mobile phone) then fed into a broadcasting application on the communication device that compresses the video content and transmits it to a remote video content server owned by a third-party streaming service (e.g., Youtube®, Facebook®, Twitch®), over a communication network, typically cellular or Wi-Fi. The remote video content server, on receiving the ingest video content stream transcodes it into a handful of compressed versions (e.g., ABR tracks) at different quality levels, with each ABR track can comprise several video segments (usually 2-10 seconds each). Viewers watching the live stream request a mixture of segments from the video content server using adaptive bitrate (ABR) streaming over the downlink distribution path from the video content server to the users. Existing technology solutions have focused a lot on the design of the last-mile downlink distribution path from the video content server to the viewers. There has been little exploration of the technology solutions of first-mile uplink ingest path from the broadcasting application to the video content server. However, this first mile uplink ingestion path can be significant to the end- to-end (E2E) performance of the live video content streaming pipeline. A determining factor for the end-to-end live video content streaming Quality of Experience (QoE) is the design of the first-mile uplink ingest path that captures and transmits the live video content in real-time, from the video capture device to the remote video content server. This first-mile uplink ingest path often involves either a Wi-Fi or cellular communication network, and is likely to be bandwidth-constrained with time-varying capacity, making the task of high-quality video delivery challenging. The E2E QoE of live video content streaming is fundamentally constrained by a single video content stream delivered over the first-mile uplink ingest path. First, the quality of the video content delivered on this path to the video content server imposes an upper limit on the quality of the ABR tracks created from it, and therefore on the QoE of the viewers of the live video content stream. Second, a video content player on the communication device that presents the video content can only download a video segment after the corresponding video content is uploaded to the video content server, imposing a latency dependency. In addition to delivering a good quality video content stream to the video content server, the first mile uplink ingest path also needs to deliver the video content with low latency. Any latency on the first mile uplink ingest path impacts the overall E2E latency for the end viewers. It is important to deliver the video content on the first mile uplink ingest path at high quality with minimal impairments, as this becomes the source reference used for the ABR track encoding and video content streaming delivery to end users, and hence its quality constrains the QoE of end users. Improving the uplink ingest performance would benefit the QoE of all the downlink viewers. However, achieving this goal is also challenging due to the usually more dynamic and limited wireless uplink resources, e.g., cellular uplink. Existing uplink ingest designs show that the bandwidth limits and variability on that uplink ingestion path makes this task difficult. Many live broadcasts are originated from mobile devices and transmitted using available over-the-air communication networks such as WiFi or cellular networks to the remote video content server. While they offer the convenience of widespread availability, cellular uplink paths tend to be resource constrained and exhibit bandwidth variability over time.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIGS. 2A-2D is a block diagram illustrating an example, non-limiting embodiment of a system functioning within the communication network of FIG. 1 in accordance with various aspects described herein.

FIGS. 2E-2G depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments that can include a virtual camera, a network emulator, a traffic collector, a segment downloader, a processing system including a processor, and a memory that stores executable instructions that, when executed by the processing system, facilitate performance of operations. Embodiments include obtaining a video file, decoding the video file to obtain a group of raw frames, and providing the group of raw frames to the virtual camera. The virtual camera generates video content from the group of raw frames. Further embodiments can include providing the video content to a broadcasting application on a first communication device, and the broadcasting application provides a first group of output frames. Additional embodiments can include providing a group of network conditions that are applied to the first group of output frames from the network emulator resulting in a group of conditioned output frames. The group of conditioned output frames are provided to a video content server from the first communication device. The video content server provides a first group of ABR tracks to a second communication device in response to receiving a first group of requests for the first group of ABR tracks from the second communication device. The first group of ABR tracks are associated with the group of conditioned output frames. Also, embodiments can include obtaining the group of conditioned output frames from the first communication device utilizing the traffic collector, obtaining the first group of ABR tracks from the video content server utilizing the segment downloader, and obtaining the first group of requests from the second communication device utilizing the segment downloader or some other appropriate methods. Further embodiments can include analyzing the group of conditioned output frames, the first group of ABR tracks and the first group of requests resulting in an analysis, and generating a first group of metrics associated with the broadcasting application based on the analysis. Other embodiments are described in the subject disclosure.

One or more aspects of the subject disclosure include a device, comprising a virtual camera, a network emulator, a traffic collector, a segment downloader, a processing system including a processor, and a memory that stores executable instructions that, when executed by the processing system, facilitate performance of operations. The operations can comprise obtaining a video file, decoding the video file to obtain a group of raw frames, and providing the group of raw frames to the virtual camera. The virtual camera generates video content from the group of raw frames. Further operations can comprise providing the video content to a broadcasting application on a first communication device. The broadcasting application provides a first group of output frames. Additional operations can comprise providing a group of network conditions that are applied to the first group of output frames from the network emulator resulting in a group of conditioned output frames. The group of conditioned output frames are provided to a video content server from the first communication device. The video content server provides a first group of ABR tracks to a second communication device in response to receiving a first group of requests for the first group of ABR tracks from the second communication device. The first group of ABR tracks are associated with the group of conditioned output frames. Also, the operations can comprise obtaining the group of conditioned output frames from the first communication device utilizing the traffic collector, obtaining the first group of ABR tracks from the video content server utilizing the segment downloader, and obtaining the first group of requests from the second communication device utilizing the segment downloader. Further operations can comprise analyzing the group of conditioned output frames, the first group of ABR tracks and the first group of requests resulting in an analysis, and generating a first group of metrics associated with the broadcasting application based on the analysis.

One or more aspects of the subject disclosure include a non-transitory, machine-readable medium, comprising executable instructions that, when executed by a processing system including a processor, facilitate performance of operations. The operations can comprise creating a video file, decoding the video file to obtain a group of raw frames, and providing the group of raw frames to a virtual camera. The virtual camera generates video content from the group of raw frames. Further operations can comprise providing the video content to a broadcasting application on a first communication device. The broadcasting application provides a first group of output frames. Additional operations can comprise providing a group of network conditions that are applied to the first group of output frames from a network emulator resulting in a group of conditioned output frames. The group of conditioned output frames are provided to a video content server from the first communication device. The video content server provides a first group of ABR tracks to a second communication device. The first group of ABR tracks are associated with the group of conditioned output frames in response to receiving a first group of requests for the first group of ABR tracks from the second communication device. Also, the operations comprise obtaining the group of conditioned output frames from the first communication device utilizing a traffic collector, obtaining the first group of ABR tracks from the video content server utilizing a segment downloader, and obtaining the first group of requests from the second communication device utilizing the segment downloader. Further operations comprise analyzing the group of conditioned output frames, the first group of ABR tracks and the first group of requests resulting in an analysis, generating a group of metrics associated with the broadcasting application based on the analysis, and providing instructions to the first communication device that indicate to adjust the broadcasting application logic or adjust the broadcasting application transmission based on the group of metrics resulting in an adjusted broadcasting application.

One or more aspects of the subject disclosure include a method. The method can comprise obtaining, by a processing system including a processor, a video file, decoding, by the processing system, the video file to obtain a group of raw frames, and providing, by the processing system, the group of raw frames to a virtual camera. The virtual camera generates video content from the group of raw frames. Further, the method can comprise providing, by the processing system, the video content to a broadcasting application on a first communication device. The broadcasting application provides a first group of output frames. In addition, the method can comprise providing, by the processing system, a group of network conditions that are applied to the first group of output frames from a network emulator resulting in a group of conditioned output frames. The group of conditioned output frames are provided to a video content server from the first communication device. The video content server provides a first group of ABR tracks to a second communication device. The first group of ABR tracks are associated with the group of conditioned output frames in response to receiving a first group of requests for the first group of ABR tracks from the second communication device. Also the method can comprise obtaining, by the processing system, the group of conditioned output frames from the first communication device utilizing a traffic collector, obtaining, by the processing system, the first group of ABR tracks from the video content server and utilizing a segment downloader, and obtaining, by the processing system, the first group of requests from the second communication device utilizing the segment downloader. Further, the method can comprise analyzing, by the processing system, the group of conditioned output frames, the first group of ABR tracks and the first group of requests resulting in an analysis, generating, by the processing system, a group of metrics associated with a communication link based on the analysis, wherein the communication link communicatively couples the first communication device and the video content server, and providing, by the processing system, instructions to the first communication device that indicate to adjust the broadcasting application based on the group of metrics resulting in an adjusted broadcasting application.

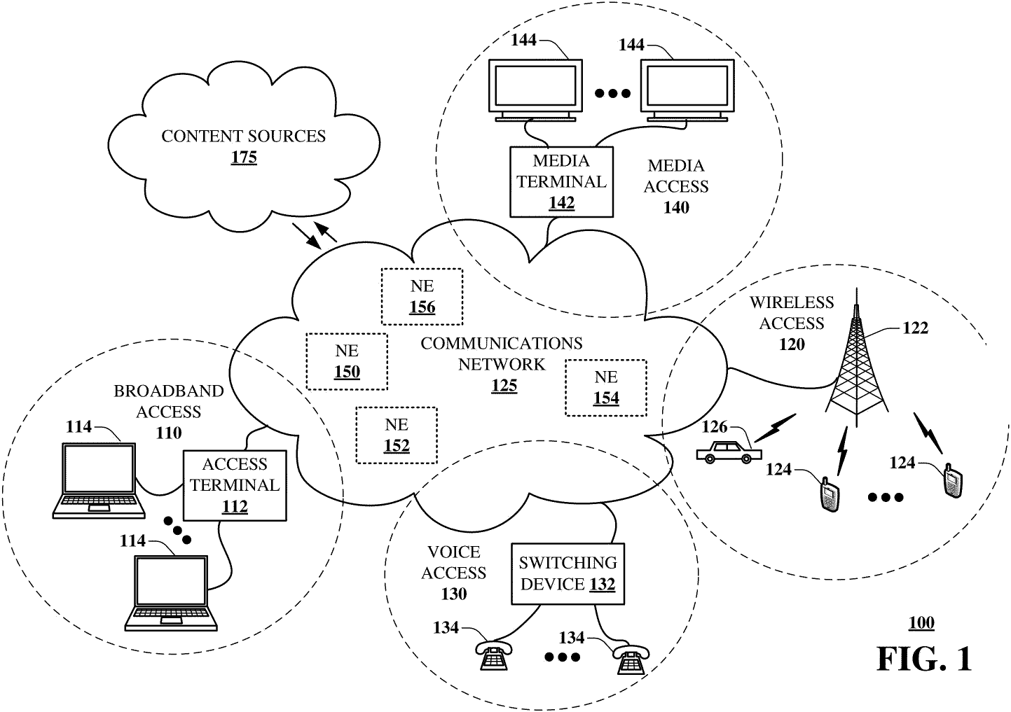

Referring now to FIG. 1, a block diagram is shown illustrating an example, non-limiting embodiment of a system 100 in accordance with various aspects described herein. For example, system 100 can facilitate in whole or in part for measuring uplink ingest performance of live video content streaming. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11 n, 802.11 ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

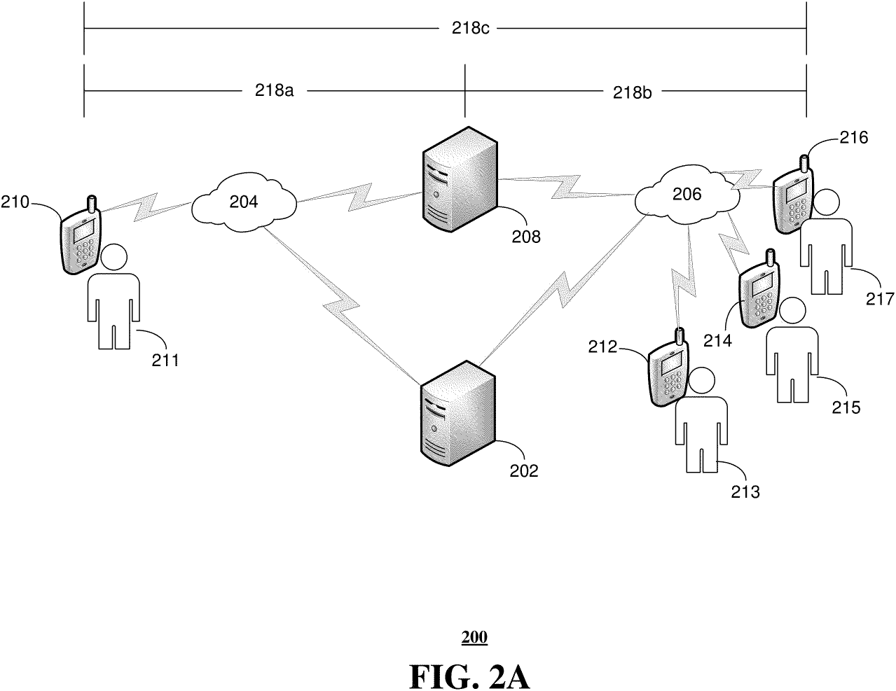

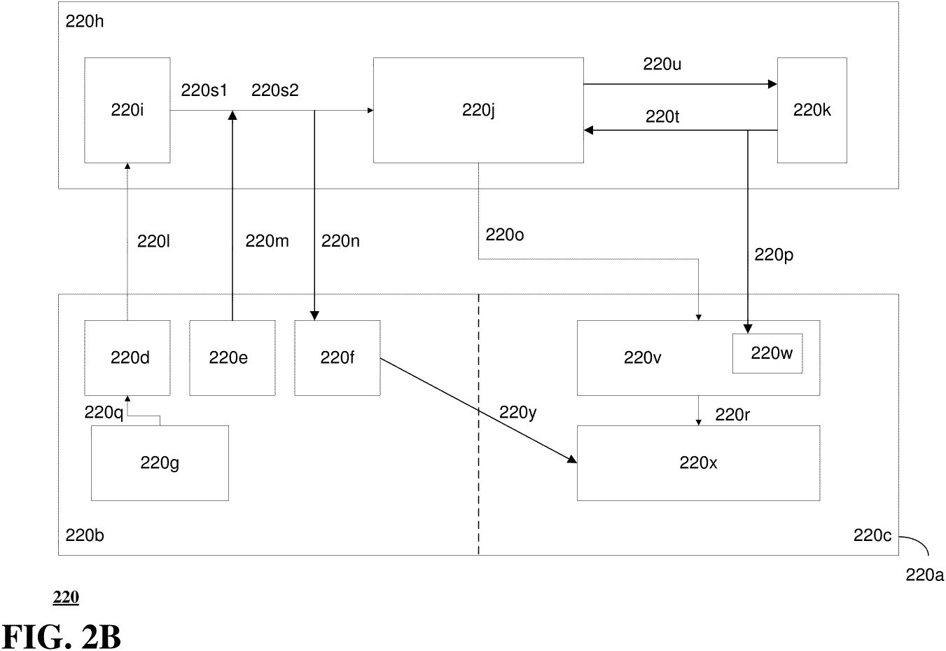

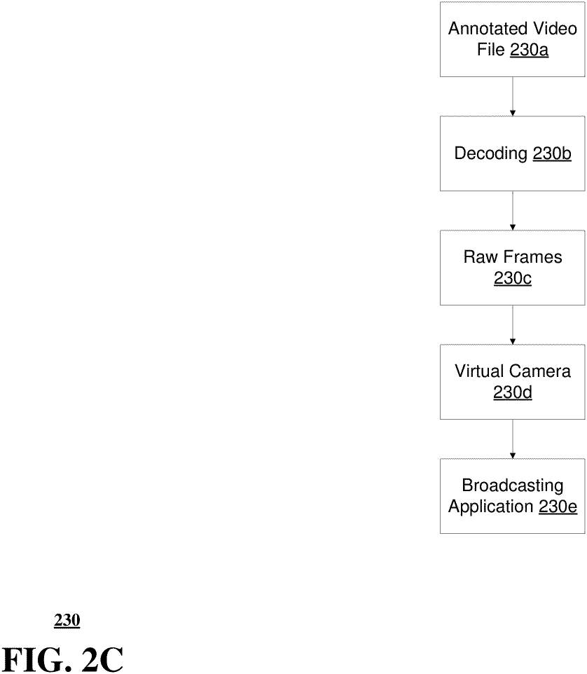

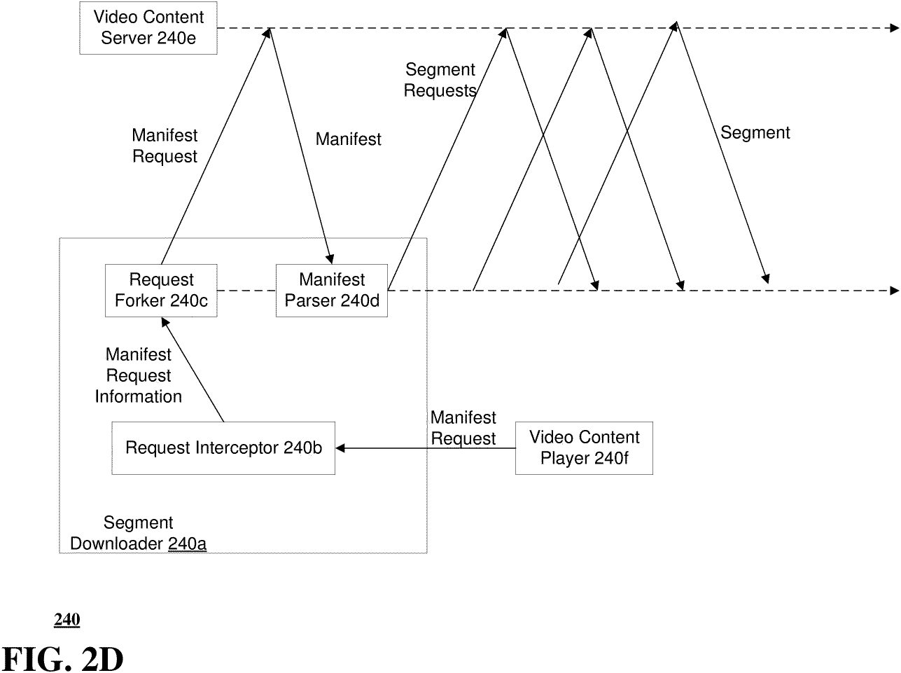

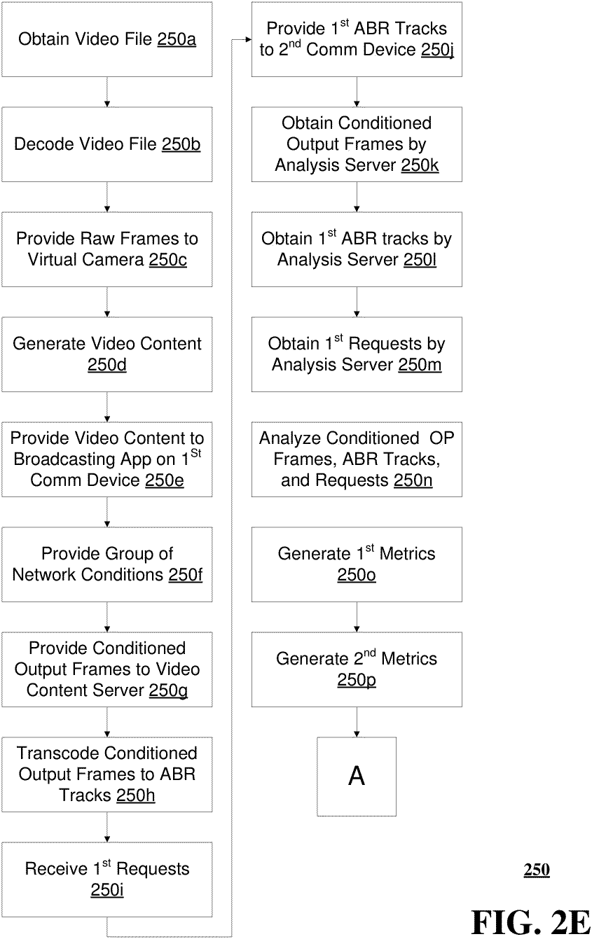

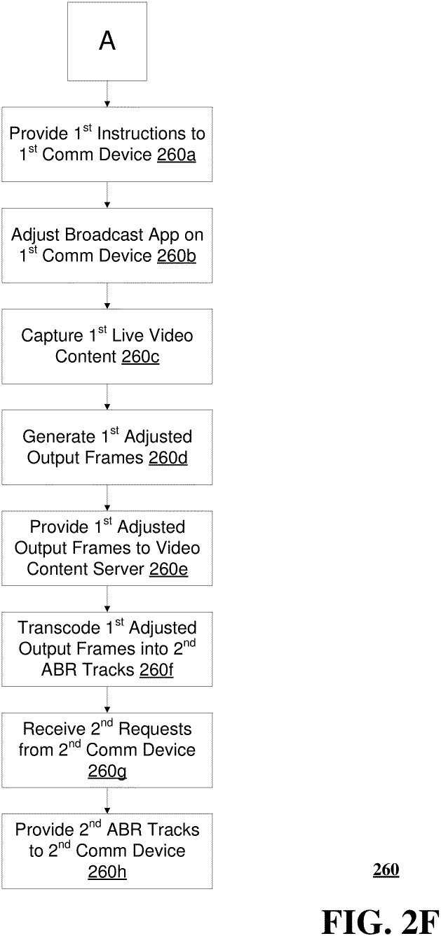

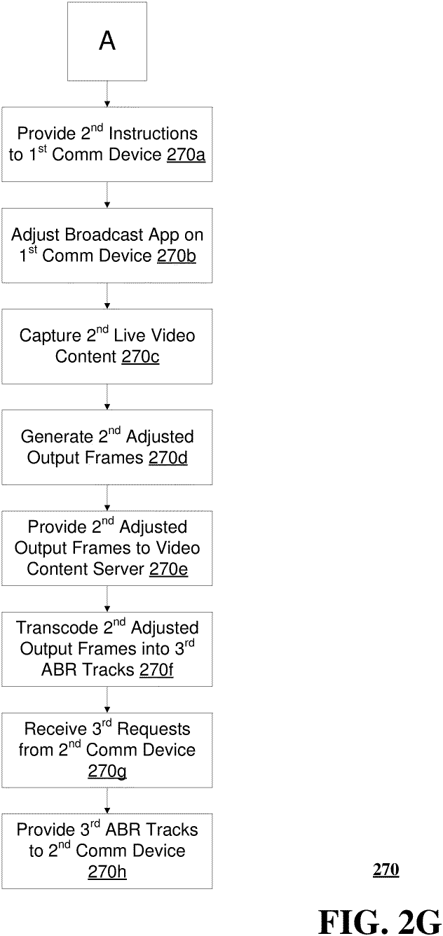

FIGS. 2A-2D is a block diagram illustrating an example, non-limiting embodiment of a system functioning within the communication network of FIG. 1 in accordance with various aspects described herein. Referring to FIG. 2A, in one or more embodiments, system 200 comprises an analysis server 202 that is communicatively coupled to a communication device 210 over communication network 204, communicatively coupled to a video content server 208 over communication network 204 and/or communication network 206, and communicatively coupled to communication device 212, communication device 214, and communication device 216 over communication network 206. Further, user 211 can be associated with communication device 210, user 213 can be associated with communication device 212, user 215 can be associated with communication device 214, and user 217 can be associated with communication device 216. Any number of users, devices, servers and/or networks can be utilized in system 200.

In one or more embodiments, the communication device 210 can capture live video content and provide the live video content to the video content server 208 over communication network 204. This can be called the uplink ingestion path 218a. Examples of capturing live content can be members of an audience live streaming a concert or sporting event as well as any live event (e.g., spontaneous video streaming, entertainment performance, news event, etc.) Further, the video content server 208 can transcode the live video content into groups of ABR tracks and provide portions of a group of ABR tracks to each of communication device 212, communication device 214, and/or communication device 216 over communication network 206 in response to receiving requests for the portions of ABR tracks from each of communication device 212, communication device 214, and/or communication device 216 over communication network 206. This can be called the downlink distribution path 218b. The uplink ingestion path 218a and the downlink distribution path 218b can comprise a live streaming pipeline 218c. In further embodiments, prior to capturing and streaming video content from communication device 210 to communication device 212, communication device 214, or communication device 216 via video content server 208, the analysis server 202 can measure metrics associated with a broadcasting application on communication device 210 that captures the live video content and provide the live video content to the video content server 208 and measure metrics associated with a communication link over communication network 204 associated with the uplink ingestion path 218a. In addition, the analysis server 202 can provide instructions to the broadcasting application on communication device 210 to improve the QoE of the delivery of live video content from the communication device 210 to communication device 212, communication device 214, or communication device 216 based on these metrics.

In one or more embodiments, each of communication device 210, communication device 212, communication device 214, and communication device 216 can comprise a mobile device, mobile phone, tablet computer, virtual reality device, augmented reality device, smartwatch, wearable device, or any other communication device. Further, each of communication network 204 and communication network 206 can comprise a wireless communication network, a wired communication network, or a combination thereof. Also, each of analysis server 202 and video content server 208 can comprise one or more servers in one location, multiple servers spanning several locations, one or more virtual servers residing one location or spanning several locations, or one or more cloud servers.

In one or more embodiments, to understand how well today’s mobile uplinks support the needs of live video ingest, one can measure the uplink performance relative to the live ingest bandwidth requirements of commercial broadcasting applications on communication device 210. Specifically, one can conduct uplink throughput measurements by uploading a large file over multiple LTE networks, covering various scenarios involving different movement patterns, signal strengths, and locations. Such exemplary measurements indicate that the uplink bandwidth exhibits significant variability and can be lower than the sustained bandwidth requirements of commercial broadcasting apps (~1-4 Mbps for many live streaming systems): the 5th percentile bandwidth values of the 10 exemplary traces are all less than 2.5 Mbps, and 4 of them have a median value less than 2.1 Mbps. While 5G is expected to further improve the bandwidth, the technology is not widely deployed yet and suffers from certain challenges (e.g., mmWave is vulnerable to mobility and blockage). Also, the 5G uplink is still expected to be relatively resource constrained, making it important for broadcast applications using it to be designed appropriately. Designing a live streaming system with good performance characteristics is challenging. As a result, existing designs exhibit high diversity across commercial services and keep involving over time. To be able to identify performance issues and thereby develop better designs, it is important to build the technical capability to be able to measure, profile and understand the design and performance of commercial live video streaming pipelines. Developing these insights is significant for assisting developers to identify deficiencies and create better designs with improved QoE, and network providers to better understand and manage the associated traffic. Different entities, including the streaming service developer, network operators, and third-party testing services need to conduct such evaluations for a range of use cases, such as identifying and improving design inefficiencies, diagnosing QoE problems during streaming, understanding player performance under different network for optimization etc. As these commercial services tend to be proprietary closed systems, little is authoritatively known about the inner workings of these systems, making this task challenging. Also, different live streaming services differ significantly in terms of various design choices and exhibit quite different streaming performances. In spite of its importance, today there exists little understanding of the state of the art in the design of this important first-mile live streaming component, with existing research focused mostly on the downlink distribution path 218b, from the video content server 208 to communication devices 212, 214, 216 associated with users 213, 215, 217 (e.g., end viewers). Given its importance, embodiments described herein develop a novel, generalized black-box measurement methodology and tool for accurately analyzing the performance of the uplink ingest path 218a, for commercial live streaming systems. The goal is to be able to analyze a wide range of commercial live video broadcasting applications on communication device 210 and streaming services from an objective third-party point of view, in a controlled, repeatable, and fine-grained manner. This task is made challenging by the complex live streaming pipeline 218c, the proprietary closed-source software components, and the wide diversity of designs across different live streaming systems. The live nature of the video content introduces further challenges in conducting repeatable measurements. The tool enables third-parties to conduct active measurements to profile the performance of the first-mile ingest aspect of live streaming, under a variety of network conditions in a repeatable and controlled manner, and thereby gain insights into the corresponding design, identify design deficiencies that lead to poor performance, and propose best practice design recommendations to improve the same. Evaluation of the uplink ingest path 218a by the tool demonstrates that the developed technique is accurate and effective in analyzing and characterizing the all-important uplink ingest path 218a of the live streaming pipeline 218c. Such a technique is valuable for a large range of entities including Internet Service Providers (ISPs), third party testers etc. and can be beneficial for many use cases.

In one or more embodiments, a novel black-box measurement methodology and tool is developed for accurately analyzing the performance of the uplink ingest path 218a, for commercial live streaming systems. The design goals can include an accurate measurement system for ingest path analysis should be able to meet the following requirements: 1) analyze commercial live streaming services from a third-party such as another developer or a network operator who usually does not have access to the source code of the service; 2) generally applicable to different live video broadcast and distribution platforms instead of targeting a specific setup; 3) being able to flexibly control different performance-impacting factors such as the network bandwidth and fairly compare different runs with different settings; and/or 4) capable of measuring performance dynamics at a fine timescale and reason about different metrics together to understand the ingest component design. Achieving the above goals is technically challenging and not straightforward because live streaming ingest itself has a complex and heterogeneous pipeline alongside the live nature of the video content, imposing the following challenges that the tool needs to address.

One or more embodiments address the complex live streaming pipeline 218c. That is, live video ingest involves a number of sensing, computing, and communication stages. The broadcasting application on communication device 210 captures video content from a camera on communication device 210, encodes it using a codec with an encoding rate control scheme, and transmits video frames to the video content server 208 using transport protocols designed for multimedia. The broadcasting application can implement different rate adaptation schemes at different points specifying different ways to cope with varying network conditions. The video content server 208 transcodes the video frames in the incoming video stream into ABR tracks for each segment of the video content. Each of them plays an important role and can affect the end-to-end QoE. This complexity makes it difficult to identify, exercise, and thus understand the key pieces that impact the QoE.

In one or more embodiments, the heterogeneous design of the live streaming pipeline 218c. That is, different streaming services can have different designs. Even for the same streaming service, the streaming service can choose different broadcasting applications such as, for example the Facebook’s ® web page in a browser, the Facebook ® mobile application, or a broadcasting application from third parties. Unlike the downstream distribution path 218b from the video content server to viewers, where ABR streaming is the predominant approach, there is no single de facto deliver solution on the uplink ingest path 218s. In fact, a wide range of ingest solutions (e.g., Real-Time Messaging Protocol (RTMP), Web Real-Time Communication (WebRTC), Faster Than Light (FTL), Dynamic Adaptive Streaming over HTTP Industry Forum (DASH-IF), Live Media Ingest, etc.) with varying degrees of specifications are available. Many of them are proprietary - therefore full protocol specifications or parsing tools may not be easily or widely available. This makes design goals challenging for live video ingest.

One or more embodiments address proprietary systems. That is, live streaming systems usually run proprietary closed-source software. A third party oftentimes does not have visibility into the source code of broadcasting applications and video content servers. In addition, the increasing use of E2E traffic encryption renders information above the network layer inaccessible, rendering approaches to extract information based on analyzing network traffic less useful. The uplink network traffic is also usually encrypted, e.g., broadcasting applications may use RTMPS or WebRTC with DTLS. In addition, the increasing use of SSL pinning in mobile applications renders Man-In-The-Middle (MITM) proxy based approaching increasingly unusable.

One or more embodiments address the live nature of video content. That is, unlike Video-On-Demand (VoD) in which the same video content can be replayed across multiple experimental runs, live streaming content is generated in real time. This makes repeating experiments using the same source difficult.

One or more embodiments address the need for suitable metrics. That is, an end user watches video content that can flow over both the ingest and the distribution path from the video content server to end viewers. The focus is on the uplink ingest path 218a, thus there is a need to understand its performance and implications for the end-end QoE. While there have been well-defined QoE metrics (e.g., quality, stall ratio, startup delay) for the downlink distribution path 218b, there are no well-defined standard performance metrics for the uplink ingest path 218a.

One or more embodiments can include a measurement system that includes the tool described herein. In view of the challenges listed above, the tool can include a holistic system to comprehensively examine the ingest performance of different broadcasting applications streaming to different services that comprises software and/or hardware. Referring to FIG. 2B, the tool can run on an analysis server 220a that interacts with the live streaming pipeline 220h by generating video source content 2201 and uplink traffic control rules (TCR) 220m, monitoring the upstream network packets (NP), and collecting ABR track and manifest information. The tool on the analysis server 220a comprises components running on a test device side 220b and an analysis side 220c of an analysis server 220a. The test device side 220b can send video source content 2201 as input frames to different broadcasting applications 220i and part of the tool annotates video source content 2201, injects them to the broadcasting applications 220i on a communication device, automates measurement tasks, and sends local measurement data to the analysis side 220c after measurement sessions. The analysis side 220c runs the rest of too that downloads the top ABR track and video manifests, and later analyzes the ingest performance offline.

One or more embodiments can perform black-box based testing. That is, it would be preferable to have visibility of every internal point on the ingest path, e.g., the encoder output frames 220s of the broadcasting application and the application data in the network uplink. However, as mentioned earlier, commercial streaming services and broadcasting applications are usually closed systems. Hence, it is difficult to access either the ingest endpoint of the video content server 220j to gain visibility into the uploaded frames or the encoder of the broadcasting application to examine the compressed frames. Given the lack of such internal visibility, the tool designs a black-box approach. Specifically, both the input (i.e., the video content) and the ingest components (e.g., broadcasting application, streaming service, network condition, etc.) are controlled, and the tool observes the output (e.g., quality of ABR track 220o). By changing the input or/and the ingest settings (e.g., through issuing different TCR), the tool can observe how the output would be affected and reason about the ingest components. A testing scheme recreates real network conditions on the ingest path from the broadcasting application to the remote video content server 220j by using a network emulator 220e (e.g., based on Linux) to replay real-world uplink network bandwidth traces by issuing different traffic control rules (TCR). The traffic collector module 220f runs a traffic collector tool (e.g. tcpdump) on the test device side 220b to collect uplink network packets. The testing scheme also runs a segment downloader 220v that collects video content server output for performance analysis. For scalable testing, the broadcasting and playback processes are automated (e.g., through Android UI automation and Selenium for browser automation).

One or more embodiments can perform a virtual video capture function. As mentioned above, the performs measurements in a controlled, repeatable way. This can translate into two requirements: First, the tool needs to be able to feed the same video content to different broadcasting applications. Second, the tool needs to be able to feed the same video content to the same broadcasting application across different runs. The first requirement comes from the need to fairly compare different broadcasting applications and streaming services. The second requirement is due to the fact that for a same (broadcasting application, streaming service) setting the tool may want to vary a factor (e.g., network condition) over different runs and keep other factors including the video source the same to examine the sole impact of this specific factor on ingest performance. One way to address this is to capture the same scene using a camera in the real world. This approach has several issues. First, it is difficult to provide a same physical scene multiple times in the real world where time and space cannot be reverted. Second, even if the tool can provide a “repeatable” physical scene (e.g., play a prerecorded video on another screen), this still makes it difficult to keep the captured video exactly the same due to lighting and camera distortion. For example, the captured image can actually contain the addition of two consecutive frames due to the way cameras work, which causes bad interactions with other necessary measurement components such as source annotation. Some broadcasting applications support local file input, but not every broadcasting application supports this mode. For example, browser-based broadcasting applications only support camera or screen sharing mode, mobile-based broadcasting applications (e.g., the Facebook® and Instagram®) only support camera mode. Screen sharing also introduces non-deterministic distortion in the screen recording process, making the video captured by a broadcasting application (i.e., the recorded screen) an approximation of the original source video. To provide a universal interface to commercial broadcasting applications for capturing repeatable video contents, the tool can create a virtual camera 220d function. It takes a local video file as input and acts as an external camera so broadcasting applications on the controller can recognize it. The video source can be fed into the virtual camera at different frame rates. It can decode a video file at its original frame rate into frames and redirect the decoded frames to the virtual camera (See FIG. 2C). The broadcasting application then captures input frames by sampling these raw frames based on the broadcasting application’s frame rate setting.

Referring to FIG. 2C, one or more embodiments craft video content files. Given the virtual camera 230d, the tool needs to prepare video sources as the input to it. For measuring both frame loss and quality of delivered video on the ingest path, the tool needs to be able to associate each frame in the received video content with its corresponding frame in the source. Achieving this frame alignment is challenging in the context of live video ingest because the frames in the source and received video content are not naturally aligned for a number of reasons. First, different broadcasting applications could capture video at different frame rates. Second, during transmission to the remote video content server, a broadcasting application may drop frames to adapt to varying network conditions. Third, depending on its joining time in the live event, a video content player may not necessarily start playing video content from the beginning of a broadcast, therefore the first frame being played may be different from the first frame captured by the broadcasting application. In addition, depending on the level of time synchronization between when the camera is turned on and when the broadcaster starts streaming to the remote video content server, even the first frame captured (to be encoded) by the broadcasting application may be different from the first frame that is seen by a turned-on camera. One approach for achieving frame alignment would be to compare every frame in the received video content and every frame in the source based on content similarity. However, the challenge with this approach is that in case of a static or a repeating scene multiple frame in the source would be visually similar to each other and in this case a frame in the received video content may be mapped to multiple frames in the source, making unambiguous frame alignment difficult. To achieve frame alignment, the tool overlays a unique signature to every source frame, and leverage computer vision techniques to detect the signatures from frames in the received video content in order to match each of them to a source frame. The signature should be robust to compression artifacts (i.e., still recognizable from low bitrate streams created under poor network conditions). In one embodiment, the tool leverages Quick Response (QR) code as this specific signature as it is more robust than overlaying digits (e.g., frame numbers) due to its use of Reed-Solomon error correction. In addition, the tool also pads the source video content with dummy frames before and after the original video content to make sure that the video content gets captured and eventually played regardless of the level of time synchronization.

One or more embodiments analyze uplink ingest path performance. As mentioned above, the tool defines performance metrics on the ingest path that have real impact on end viewer QoE. The metrics can include: video quality, effective frame rate, ingest delay, and ingest induced stall as follows. To facilitate uplink ingest path performance analysis, the tool measures what is delivered to the video content server and when. However, extracting video frames in such a stream on the ingest path is challenging. Instead, the tools uses the transcoded top ABR track (TAT) to approximate the above stream because TAT can be easily accessible using standard APIs (e.g., HTTP APIs) from the distribution path. The TAT is also more closely associated with the end viewers’ experience as the players ultimately need to fetch video segments from ABR tracks, and the TAT represents the best quality encoding any user can receive. The live streaming methodology involves running a segment downloader to fetch the TAT. In one instantiation of this capability, the tool parses the corresponding live video manifest for the session to obtain the address information for the TAT, which is passed to the segment downloader for downloading the TAT segments. During the live stream, the manifest is periodically updated over time as new segments are generated at the video content server. The segment downloader fetches these updated versions at regular intervals to extract information required for computing the various performance metrics described next.

One or more embodiments address video quality. The tool can examine the quality of video segments in the top ABR track (TAT) created by the video content server. TAT represents an upper bound on the video quality experienced by any user served by the video content server. The quality of TAT depends on the quality of the content received by the video content server on the ingest path, which is the cumulative result of all ingest activities (including broadcasting application encoding and adaptation, network performance, etc.). Specifically, the tool can compute the Video Multimethod Assessment Fusion (VMAF), which is a recently proposed perceptual quality metric and has been shown to perform much better than traditional video quality metrics that do not accurately capture human perception such as Peak Signal-to-Noise Ratio (PSNR) and Structural Similarity Index (SSIM). VMAF is a full-reference model allowing the tool to measure the perceptual quality of distorted video content by comparing it with regard to a pristine quality reference of the same content. Because streaming providers are particularly interested in the quality of the content consumed by mobile users, the tool can use the VMAF phone model (designed for small screens) for VMAF calculation. Since the tool is interested in measuring video quality at a fine granularity over the video session, the tool can use the arithmetic mean of the VMAF values of all the frames in a segment as the segment’s VMAF value, and analyze the distribution of per-segment VMAF values across the session. Note that while the tool can use VMAF for the reasons stated above, the tool can easily accommodate other measures of video quality, e.g., PSNR and SSIM.

One or more embodiments can address effective frame rate. Broadcasting applications may capture frames at a different frame rate (FPS) and drop frames when network bandwidth becomes insufficient. Besides, networks may drop frames and video servers may reduce frame rates as well. To quantify the impact of frame loss, the tool can define effective frame rate (effective FPS, or eFPS), which is the number of distinct frames in each second in the TAT. eFPS equals FPS when there are no duplicated frames (i.e., every frame is distinct). However, according to observations, video content servers may duplicate frames to maintain a constant FPS in ABR tracks when the frame rate on the ingest path is variable. The tool can therefore identify distinct frames and remove the duplicated ones using our frame annotation and alignment methods described above.

One or more embodiments can address ingest freshness. Streaming providers are also interested in understanding the latency impact of the ingest path, which affects the E2E broadcaster-to-viewer (B2V) delay - an indicator of how much a viewer is behind the live event. To characterize ingest freshness, define the “ingest delay” for each ABR segment as the time elapsed from when its first frame is generated at the source to when all the ABR track ladder variants for that segment becomes available for video content players to download. This segment-level delay is also more related to end users’ experience compared to frame-level delay - a segment becomes available for players to download only after all the frames in the segment arrive at the video content server and the different ABR track variants for that segment have been created. The ingest delay for a segment is the sum of the times spent on broadcasting application encoding, network transmission, and server transcoding. To facilitate ingest delay calculation, the segment downloader continuously fetches the live video manifest of ABR tracks, which keeps refreshing and contains information about the latest few segments at the server. The tool can parse each manifest to find out its last updated time. For segments that have not been present in previous versions of the manifest, the tool can mark their arrival time. The generation time of the first frame of each segment is recorded at the virtual camera. The ingest delay, or broadcasting-application-to-server (B2S) delay of a segment can thus be calculated.

One or more embodiments can address ingest smoothness. Once a viewer joins a live event, to play a live stream smoothly without stalls, the video content player needs to get subsequent ABR segments from the video content server in a timely fashion. This requires the ABR segments to be created and made available for downstream video content players in a timely fashion. However, during a live stream, if the ingest delay increases significantly (e.g., because the uplink bandwidth becomes very low for some time), the arrival of the video frames at the video content server and subsequent creation of the corresponding ABR segments can be delayed, increasing the chance that a video content player may not receive some segments in a timely fashion and therefore experience stalls. While due to live playback freshness considerations, a video content player cannot stay far behind the live edge, for many common use cases, the video content player can still start several seconds behind the live edge (it can be defined as an offset) and so can tolerate some variability in the availability time of the segments. Here, to measure the effect of this variability on user experience, the tool can assume a video content player with an X seconds offset behind the live edge (empirically set X = 10), and measure the stall behavior due to segment available time variability. The tool can define the stall ratio as the aggregate stall duration as a percentage of the total live video content session duration.

Referring to FIG. 2A and FIG. 2B, in one or more embodiments, the analysis server 202 can comprise a virtual camera 220d, a network emulator 220e, a traffic collector 220f, and a segment downloader 220v. The analysis server 202 can comprise obtaining a video file, decoding the video file to obtain a group of raw frames, and providing the group of raw frames to the virtual camera 220d. Further, the virtual camera 220d can generate video content from the group of raw frames. In addition, the analysis server 202 can provide the video content to a broadcasting application 220i on a communication device 210. Also, the broadcasting application 220i on the communication device 210 can provide a first group of output frames 220s1. Further, the network emulator 220e can provide a group of network conditions that can be applied to the first group of output frames that can result in a group of conditioned output frames 220s2. The network conditions can comprise fading, noise, packet loss, and bandwidth congestion.

In one or more embodiments, the group of conditioned output frames are provided to the video content server 220j, 208 from the communication device 210. The video content server 208 can transcode the group of conditioned output frames to a group of ABR tracks. Further, the video content server 220j, 208 can provide the group of ABR tracks that are associated with at least a portion of the group of conditioned output frames to communication device 212, communication device 214, or communication device 216 in response to receiving a group of requests for the group of ABR tracks from communication device 212, communication device 214, or communication device 216.

In one or more embodiments, the analysis server 202 can obtain the group of conditioned output frames 220n utilizing the traffic collector 220f, obtain the group of ABR tracks 220o from the video content server 220j, 208 utilizing the segment downloader, and obtain the group of requests for the group of ABR tracks 220p utilizing the segment downloader. Further, the group of conditioned output frames, group of ABR tracks, and the group of requests for the group of ABR tracks can be provided 220r, 220y to a performance analysis engine 220x. Further, the analysis server 202 can analyze the group of conditioned output frames, group of ABR tracks, and/or the group of requests for the group of ABR tracks utilizing the performance analysis engine resulting in ana analysis. In addition, the analysis server 202 can generate a group of metrics associated with the broadcasting application based on the analysis. The group of metrics can comprise video quality, effective frame rate, ingest delay, ingest induced stall, video multimethod assessment fusion (VMAF), peak signal-to-noise ratio (PSNR), and structural similarity index (SSIM).

In one or more embodiments, the analysis server 202 can provide instructions to the communication device 210 that indicate to adjust its broadcasting application based on the group of metrics resulting in an adjusted broadcasting application. Further, the communication device 210 captures live video content utilizing the adjusted broadcasting application. In addition, the communication device 210 generates adjusted output frames utilizing the adjusted broadcasting application. The communication device 210 provides the adjusted output frames to the video content server 208. Also, the video content server receives a group of requests from communication device 212, communication device 214, or communication device 216 for the live video content. Further, the video content server 208 provides a group of ABR tracks associated with the adjusted output frames to communication device 212, communication device 214, or communication device 216.

In one or more embodiments, a communication link communicatively couples the communication device 210 and the video content server 208 over a communication network 204. Further, the analysis server 202 can generate a group of metrics associated with the communication link. The group of metrics associated with the communication link can comprise latency, bandwidth consumption, and throughput. In addition, the analysis server 202 can provide instructions to the communication device 210 that indicate to adjust the broadcasting application based on the group of metrics associated with the communication link resulting in an adjusted broadcasting application. Communication device 210 captures live video content utilizing the adjusted broadcasting application. Further, the communication device generates adjusted output frames utilizing the adjusted broadcasting application. In addition, the communication device 210 provides the adjusted output frames to the video content server 208. Also, the video content server 208 receives a group of requests from communication device 212, communication device 214, or communication device 216 for the live video content. The video content server 208 provides a group of ABR tracks associated with the adjusted output frames to the communication device 212, communication device 214, or communication device 216.

In one or more embodiments, the virtual camera 220d, network emulator 220e, traffic collector, 220f, segment downloader 220v, request interceptor 220w, and performance analysis engine can each comprise software and/or hardware components on the analysis server 220a to perform each of their functions described herein.

Referring to FIG. 2C, in one or more embodiments, system 230 illustrates providing a video file by an analysis server to a broadcasting application on a communication device via a virtual camera of an analysis server. The analysis server can obtain an annotated video file 230a (from its memory, database, or repository of video files). The analysis server can decode 230b the annotated video file into raw frames 230c. The raw frames can be provided to the virtual camera 230d, which can then provide the raw frames to the broadcasting application on the communication device.

Referring to FIG. 2D, in one or more embodiments, system 240 illustrates the way in which the analysis server obtains a manifest request and segment requests from a communication device and a manifest and segments from a video content server utilizing a segment downloader 240a. The segment downloader 240a can comprise a request interceptor 240b, a request forker 240c and a manifest parser 240d. Further, the video content player 240f on the communication device can provide the manifest request to the request interceptor 240b. Further, the request interceptor can provide the manifest request information to the request forker 240c, which provides the manifest request to the video content server 240e. In addition, the manifest can be provided to the manifest parser 240d. In some embodiments, the segments requests can be provided to the request interceptor 240b by the video content player 240f, and segments can be provided to the segment downloader 240a by the video content server 240e. The manifest request, manifest, segment requests, and segments can be provided to a performance analysis engine of the analysis server to be analyzed and determine a group of metrics associated with the uplink ingest path. Further, the segment downloader 240a, request interceptor, request forker, and manifest parser can each comprise software and/or hardware components on the analysis server to perform each of their functions described herein.

FIGS. 2E-2G depicts an illustrative embodiment of a method in accordance with various aspects described herein. Referring to FIG. 2E, in one or more embodiments, aspects of method 250 can be implemented by an analysis server, video content server, a first communication device having a broadcast application, and/or a second communication device having a video content player. Method 250 can include the analysis server, at 250a, obtaining a video file. Further, the method 250 can include the analysis server, at 250b, decoding the video file to obtain a group of raw frames. In addition, the method 250 can include the analysis server, at 250c, providing the group of raw frames to the virtual camera of the analysis server. Also, the method 250 can include the virtual camera of the analysis server, at 250d, generating video content from the group of raw frames. Further, the method 250 can include the analysis server, at 250e, providing the video content to a broadcasting application on the first communication device. The broadcasting application provides or generates a first group of output frames associated with the video content. In addition, the method 250 can include the analysis server, at 250f, providing a group of network conditions that are applied to the first group of output frames resulting in a group of conditioned output frames. In some embodiments, the group of network conditions can be provided to the first communication device that applies the group of network conditions to the first group of output frames. The group of network conditions comprise fading, noise, packet loss, and bandwidth congestion.

In one or more embodiments, the method 250 can include the broadcast application on the first communication device, at 250g, providing the group of conditioned output frames to the video content server. Further, the method 250 can include the video content server, at 250h, transcoding the group of conditioned output frames to a first group of ABR tracks. In addition, the method 250 can include the video content server, at 250i, receiving a first group of requests for the first group of ABR tracks from the second communication device. Also, the method 250 can include the video content server, at 250j, providing a first group of ABR tracks to the second communication device.

In one or more embodiments, the method 250 can include the analysis server, at 250k, obtaining the group of conditioned output frames from the first communication device utilizing a traffic collector. Further, the method 250 can include the analysis server, at 2501, obtaining the first group of ABR tracks from the video content server utilizing a segment downloader. In addition, the method 250 can include the analysis server, at 250m, obtaining the first group of requests from the second communication device utilizing the segment downloader. Also, the method 250 can include the analysis server, at 250n, analyzing the group of conditioned output frames, the first group of ABR tracks and the first group of requests resulting in an analysis. Further, the method 250 can include the analysis server, at 250o, generating a first group of metrics associated with the broadcasting application based on the analysis. A communication link communicatively couples the first communication device and the video content server over a communication network. In addition, the method 250 can include the analysis server, at 250p, generating a second group of metrics associated with the communication link based on the analysis. The first group of metrics comprise video quality, effective frame rate, ingest delay, ingest induced stall, video multimethod assessment fusion (VMAF), peak signal-to-noise ratio (PSNR), and structural similarity index (SSIM) or other perceptual video quality metrics. The second group of metrics comprise latency, bandwidth consumption, and throughput.

Referring to FIG. 2F, in one or more embodiments, aspects of method 260 can be implemented by an analysis server, video content server, a first communication device having a broadcast application, and/or a second communication device having a video content player. The method 260 can include the analysis server, at 260a, providing first instructions to the first communication device that indicate to adjust the broadcasting application based on the first group of metrics. Further, the method 260 can include the first communication device, at 260b, adjusting the broadcast application resulting in a first adjusted broadcast application. In addition, the method 260 can include the first communication device, at 260c, capturing first live video content utilizing the first adjusted broadcasting application. Also, the method 260 can include the first communication device, at 260d, generating first adjusted output frames utilizing the first adjusted broadcasting application. Further, the method 260 can include the first communication device, at 260e, providing the first adjusted output frames to the video content server. In addition, the method 260 can include the video content server, at 260f, transcoding the first adjusted output frames into a second group of ABR tracks. Also, the method 260 can include the video content server, at 260g, receives a second group of requests from the second communication device for the first live video content. Further, the method 260 can include the video content server, at 260h, providing the second group of ABR tracks associated with the first adjusted output frames to the second communication device.

Referring to FIG. 2G, in one or more embodiments, aspects of method 270 can be implemented by an analysis server, video content server, a first communication device having a broadcast application, and/or a second communication device having a video content player. The method 270 can include the analysis server, at 270a, providing second instructions to the first communication device that indicate to adjust the broadcasting application based on the second group of metrics. Further, the method 270 can include the first communication device, at 270b, adjusting the broadcast application resulting in a second adjusted broadcast application. In addition, the method 270 can include the first communication device, at 270c, capturing second live video content utilizing the second adjusted broadcasting application. Also, the method 270 can include the first communication device, at 270d, generating second adjusted output frames utilizing the second adjusted broadcasting application. Further, the method 270 can include the first communication device, at 260e, providing the second adjusted output frames to the video content server. In addition, the method 270 can include the video content server, at 270f, transcoding the second adjusted output frames into a third group of ABR tracks. Also, the method 270 can include the video content server, at 270g, receives a third group of requests from the second communication device for the second live video content. Further, the method 270 can include the video content server, at 270h, providing the second group of ABR tracks associated with the second adjusted output frames to the second communication device.

While for purposes of simplicity of explanation, the respective processes are shown and described as a series of blocks in FIGS. 2E-2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Portions of some embodiments can be combined with portions of other embodiments. The methods and steps thereof can be performed in a centralized or distributed manner including in a cloud or via a virtual machine.

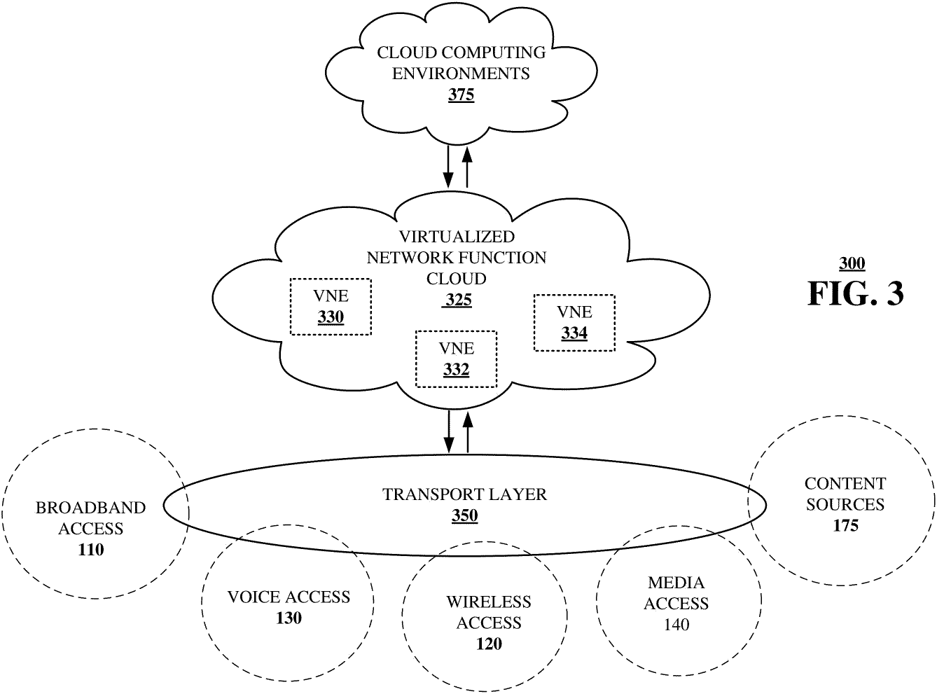

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of systems 200, 220, 230, 240 and methods 250, 260, 270 presented in FIGS. 1, 2A-2G and 3. For example, virtualized communication network 300 can facilitate in whole or in part measuring uplink ingest performance of live video content streaming.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it’s elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don’t typically need to forward large amounts of traffic, their workload can be distributed across a number of servers - each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

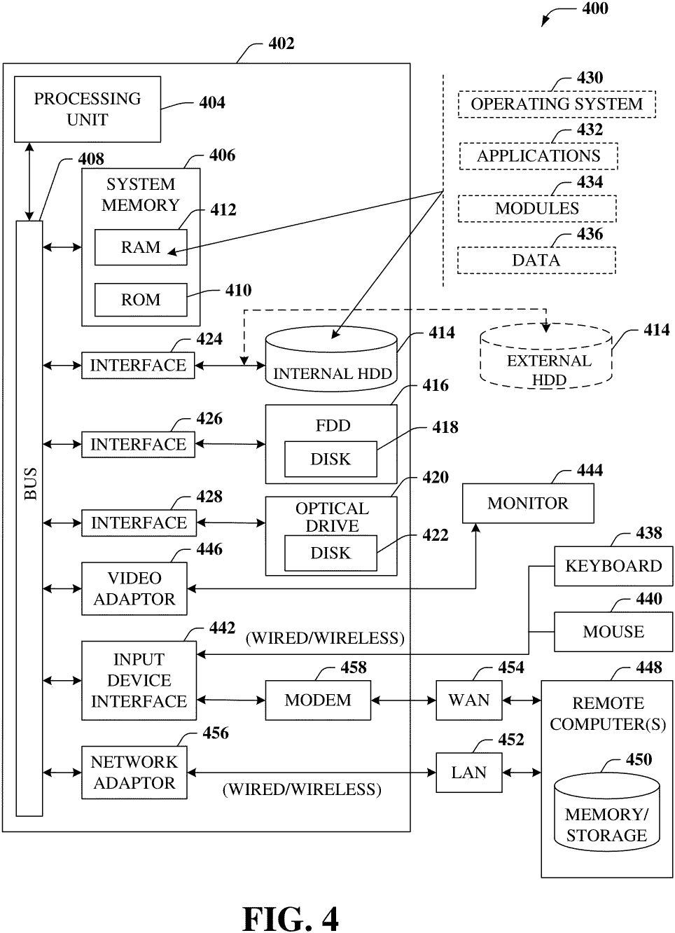

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part measuring uplink ingest performance of live video content streaming. Further, each of analysis server 202, video content server 208, communication device 210, communication device 212, communication device 214, communication device 216, analysis server 220a, communication device having broadcasting application 220i, video content server 220j, and communication device having video content player 220k can comprise computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

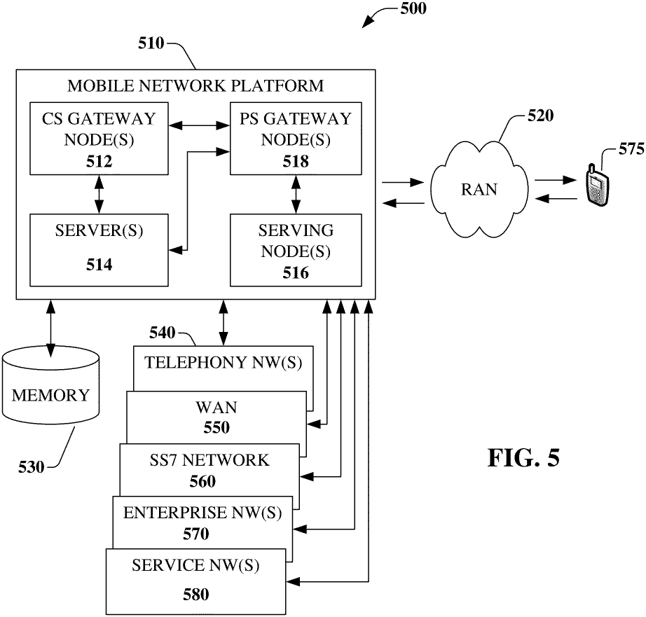

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part measuring uplink ingest performance of live video content streaming. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format ...) such flows. Such application(s) can comprise add-on features to standard services (for example, provisioning, billing, customer support ...) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network’s operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

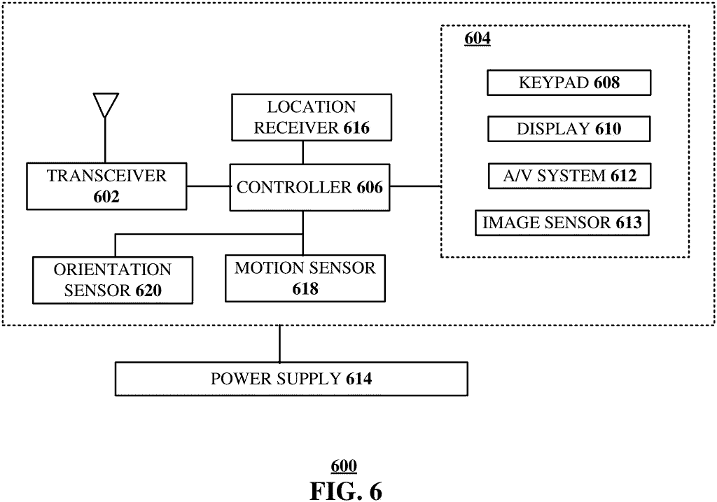

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part measuring uplink ingest performance of live video content streaming. Further, each of analysis server 202, video content server 208, communication device 210, communication device 212, communication device 214, communication device 216, analysis server 220a, communication device having broadcasting application 220i, video content server 220j, and communication device having a video content player 220k can comprise communication device 600.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user’s finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn’t otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x = (x1, x2, x3, x4, ..., xn), to a confidence that the input belongs to a class, that is, f(x) = confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A device, comprising:
a virtual camera;
a network emulator;
a traffic collector;
a segment downloader;
a processing system including a processor; and
a memory that stores executable instructions that, when executed by the processing system, facilitate performance of operations, the operations comprising:
obtaining a video file;
decoding the video file to obtain a group of raw frames;
providing the group of raw frames to the virtual camera, wherein the virtual camera generates video content from the group of raw frames;
providing the video content to a broadcasting application on a first communication device, wherein the broadcasting application provides a first group of output frames;
the network emulator providing a group of network conditions that are applied to the first group of output frames to create a group of conditioned output frames, wherein the first communication device uploads the group of conditioned output frames to a video content server , wherein the video content server generatesa first group of adaptive bitrate (ABR) tracks from the conditioned output frames and provides the first group of ABR tracks to a second communication device responsive to a first group of requests for the first group of ABR tracks received from the second communication ;
obtaining the group of conditioned output frames from the first communication device utilizing the traffic collector;
obtaining the first group of ABR tracks from the video content server utilizing the segment downloader;
obtaining the first group of requests from the second communication device utilizing the segment downloader;
analyzing the group of conditioned output frames, the first group of ABR tracks and the first group of requests resulting in an analysis; and
generating a first group of metrics associated with the broadcasting application based on the analysis.

2. The device of claim 1, wherein the first group of metrics comprise video quality, effective frame rate, ingest delay, ingest induced stall, video multimethod assessment fusion (VMAF), peak signal-to-noise ratio (PSNR), and structural similarity index (SSIM).

3. The device of claim 1, wherein the operations comprise providing first instructions to the first communication device that indicate to adjust the-broadcasting application logic based on the first group of metrics resulting in a first adjusted broadcasting application.

4. The device of claim 3, wherein the first communication device captures first live video content utilizing the first adjusted broadcasting application, wherein the first communication device generates first adjusted output frames utilizing the first adjusted broadcasting application, wherein the first communication device provides the first adjusted output frames to the video content server, wherein the video content server receives a second group of requests from the second communication device for the first live video content, wherein the video content server provides a second group of ABR tracks associated with the first adjusted output frames to the second communication device.

5. The device of claim 1, wherein a communication link communicatively couples the first communication device and the video content server, wherein the operations comprise generating a second group of metrics associated with the communication link based on the analysis.

6. The device of the claim 5, wherein the second group of metrics comprise latency, bandwidth consumption, and throughput.

7. The device of claim 5, wherein the operations comprise providing second instructions to the first communication device that indicate to adjust the broadcasting application based on the second group of metrics resulting in a second adjusted broadcasting application.

8. The device of claim 7, wherein the first communication device captures second live video content utilizing the second adjusted broadcasting application, wherein the first communication device generates second adjusted output frames utilizing the second adjusted broadcasting application, wherein the first communication device provides the second adjusted output frames to the video content server, wherein the video content server receives a third group of requests from the second communication device for the second live video content, wherein the video content server provides a third group of ABR tracks associated with the second adjusted output frames to the second communication device.

9. The device of claim 1, wherein the video content server transcodes the group of conditioned output frames to the first group of ABR tracks.

10. The device of claim 1, wherein the group of network conditions comprise fading, noise, packet loss, and bandwidth congestion.

11. A non-transitory, machine-readable medium, comprising executable instructions that, when executed by a processing system including a processor, facilitate performance of operations, the operations comprising:
creating a video file;
decoding the video file to obtain a group of raw frames;
providing the group of raw frames to a virtual camera, wherein the virtual camera generates video content from the group of raw frames;
providing the video content to a broadcasting application on a first communication device, wherein the broadcasting application provides a first group of output frames;
providing a group of network conditions from a network emulator for application to the first group of output frames,resulting in a group of conditioned output frames, wherein the first communication device uploads the group of conditioned output frames to a video content server, wherein the video content server generates a first group of adaptive bitrate (ABR) tracks from the conditioned output frames,wherein the video content server provides the first group of ABR tracks to a second communication device responsive to receiving a first group of requests for the first group of ABR tracks from the second communication device;
obtaining the group of conditioned output frames from the first communication device utilizing a traffic collector;
obtaining the first group of ABR tracks from the video content server utilizing a segment downloader;
obtaining the first group of requests from the second communication device utilizing the segment downloader;
analyzing the group of conditioned output frames, the first group of ABR tracks and the first group of requests resulting in an analysis;
generating a group of metrics associated with the broadcasting application based on the analysis; and
providing instructions to the first communication device that indicate to adjust the-broadcasting application logic based on the group of metrics resulting in an adjusted broadcasting application.

12. The non-transitory, machine-readable medium of claim 11, wherein the first communication device captures live video content utilizing the adjusted broadcasting application, wherein the first communication device generates adjusted output frames utilizing the broadcasting application, wherein the first communication device provides the adjusted output frames to the video content server, wherein the video content server receives a second group of requests from the second communication device for the live video content, wherein the video content server provides a second group of ABR tracks associated with the adjusted output frames to the second communication device.

13. The non-transitory, machine-readable medium of claim 11, wherein the group of metrics comprise video quality, effective frame rate, ingest delay, ingest induced stall, video multimethod assessment fusion (VMAF), peak signal-to-noise ratio (PSNR), and structural similarity index (SSIM).

14. The non-transitory, machine-readable medium of claim 11, wherein the video content server transcodes the group of conditioned output frames to the first group of ABR tracks.

15. The non-transitory, machine-readable medium of claim 11, wherein the group of network conditions comprise fading, noise, packet loss, and bandwidth congestion.

16. A method, comprising:
obtaining, by a processing system including a processor, a video file;
decoding, by the processing system, the video file to obtain a group of raw frames;
providing, by the processing system, the group of raw frames to a virtual camera, wherein the virtual camera generates video content from the group of raw frames;
providing, by the processing system, the video content to a broadcasting application on a first communication device, wherein the broadcasting application provides a first group of output frames;
providing, by the processing system, a group of network conditions from a network emulator that are applied to the first group of output frames to result in a group of conditioned output frames, wherein the first communication device uploads the group of conditioned output framesto a video content server, wherein the video content server generates a first group of adaptive bitrate (ABR) tracks from the group of conditioned output frames, and wherein the video content server provides the first group of ABR tracks responsive to receiving a first group of requests for the first group of ABR tracks from a second communication device;
obtaining, by the processing system, the group of conditioned output frames from the first communication device utilizing a traffic collector;
obtaining, by the processing system, the first group of ABR tracks from the video content server and utilizing a segment downloader;
obtaining, by the processing system, the first group of requests from the second communication device utilizing the segment downloader;
analyzing, by the processing system, the group of conditioned output frames, the first group of ABR tracks and the first group of requests resulting in an analysis;
generating, by the processing system, a group of metrics associated with a communication link based on the analysis, wherein the communication link communicatively couples the first communication device and the video content server; and
providing, by the processing system, instructions to the first communication device that indicate to adjust the-broadcasting application logic based on the group of metrics resulting in an adjusted broadcasting application.

17. The method of claim 16, wherein the first communication device captures live video content utilizing the adjusted broadcasting application, wherein the first communication device generates adjusted output frames utilizing the broadcasting application, wherein the first communication device provides the adjusted output frames to the video content server, wherein the video content server receives a second group of requests from the second communication device for the live video content, wherein the video content server provides a second group of ABR tracks associated with the adjusted output frames to the second communication device.

18. The method of claim 16, wherein the group of metrics comprise latency, bandwidth consumption, and throughput.

19. The method of claim 16, wherein the video content server transcodes the group of conditioned output frames to the first group of ABR tracks.

20. The method of claim 16, wherein the group of network conditions comprise fading, noise, packet loss, and bandwidth congestion.
